(19) United States
(12) Patent Application Publication
(10) Pub. No.: US 2004/0172261 A1
(43) Pub. Date: Sep. 2, 2004

(54) Method and system to dynamically determine market rent

(76) Inventors: Donald M. Davidoff, Littleton, CO (US); Christopher A. Brust, Littleton, CO (US); Richard Hughes, Arlington, VA (US)

Correspondence Address: Wayne L. Tang, MAYER, BROWN, ROWE & MAW, P.O. Box 2828, Chicago, IL, 60690-2828, US

(21) Appl. No.: 10/375,217

(22) Filed: Feb. 27, 2003

(51) Int. Cl. G06F 17/60

(52) U.S. Cl. 705/1

(57) ABSTRACT

A system and method to optimize rent for rental property management is disclosed. The system allows a user to calculate optimal rents for any variety of rental strategies using the same general algorithm. The system stores past and present competitor rents in a storage base. The rent data is taken from different users who may be in different rental locales. The system also has data relating to the last reference rent, a factor indicating aggressiveness in renting, a medium brake factor at which rent is lowered to that of the competitors and a high brake factor. The reference rent is calculated by a rent engine using these variables. The user may adjust the data for different rental strategies. The system allows a user to display the rent values for different unit types and break down the data into discrete samples.

### FIELD OF INVENTION

This invention relates to a method and system to determine the market rent of lease properties and more specifically to a system and method that determines the optimal rent for a variety of different rental strategies.

### BACKGROUND OF INVENTION

A primary challenge for a property management company is to maximize revenues from new and renewal leases by setting a maximum rent but still keeping all their units occupied. Under pressure to increase revenues from operations, property-management companies face extremely complex issues of pricing and capacity allocation. Multi-family units are large fixed assets whose single greatest liability is vacancy cost or exposure. Units cannot be allowed to remain vacant if suitable demand for them exists, but attempting to maximize revenue means more than simply maximizing occupancy. A property manager's rental products are not determined by the actual units, but rather a combination of timing and a balance of supply and demand. Successfully meeting this complex pricing challenge in the most efficient and profit maximizing manner involves determining market rent.

In order to maximize revenues, a property manager must precisely forecast and analyze market demand unit availability to set a market rent which is optimal. The ideal market rent is obtained by measuring dynamic consumer demand. To achieve these goals, the property manager must calculate the economic value of each unit type in the marketplace and determine the optimal effective base rents as well as rents for move-ins and renewals. The property manger also preferably forecasts rental demands during different time periods, as well as regularly re-optimizes rents in response to changing demand, availability and market conditions. Moreover these calculations need to be repeated on a periodic basis.

Recently, this has been simplified by the availability of software decision support tools that apply differential pricing strategies and the smart allocation of capacity. However, calculations made by existing rent calculation software is rigid and cannot be adapted to individual pricing strategies which often vary according to market conditions. In order to adapt standard formulas to pricing formulas, a great deal of time must be spent to adjust variables making the existing calculation software cumbersome to use or in some cases not useful in a rapidly changing rental market.

Thus, there is a need for an automated system to calculate market rent given dynamic consumer factors. There is a further need for a system which may be adapted to different strategies for pricing rents. There is also a need for a system which does not require constant updating of additional data to determine changing optimal rent values.

### SUMMARY OF THE INVENTION

These needs and others may be met by the present invention which is a method of calculating the optimal rent for a property. Competitive data relating to past and current competitor rent is gathered. Previous reference rent data is stored. Parameters for rental strategy including an aggressive factor, a high brake factor, and a medium brake factor is determined. Optimal reference rent is calculated based on weighting current competitor rent, the reference rent data, the aggressive factor, the high brake factor, the medium brake factor and the past competitor rent

Another example of the invention is a system for calculating optimal rental rates for a variety of renting strategies. The system has a storage device storing data relating to past reference rents, past competitor rents and present competitor rents. An input device accepts initial parameters including an aggressive factor, a high brake factor, and a medium brake factor. A rent optimizer engine is coupled to the storage device and the input device which periodically calculates the optimal rent based on weighting current competitor rent, the reference rent data, the aggressive factor, the high brake factor, the medium brake factor and the past competitor rent.

It is to be understood that both the foregoing general description and the following detailed description are not limiting but are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

These and further aspects and advantages of the invention will be discussed more in detail hereinafter with reference to the disclosure of preferred embodiments, and in particular with reference to the appended Figures wherein:

FIG. 1 is block diagram of the system for determining market rent according to one example of the present invention;

FIG. 2 is a flow diagram of the process used by the system in FIG. 1 to determine the optimal market rent;

FIG. 3 is a screen print of a community data entry screen for the system of FIG. 1 for determining market rent;

FIGS. 4A-4C are screen prints of competitor data entry screens which are accessible through the community data entry screen of FIG. 3;

FIG. 5 is a screen print of an entry screen for lease term category data;

FIG. 6 is a screen print of an entry screen for market conditions data;

FIG. 7 is a screen print of an entry screen for reference rent;

FIG. 8 is a screen print of a rent graph which may be displayed by the system of FIG. 1;

FIG. 9 is a screen print of a web page accessible for field data entry by property managers.

### DESCRIPTION OF THE PREFERRED EMBODIMENT

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

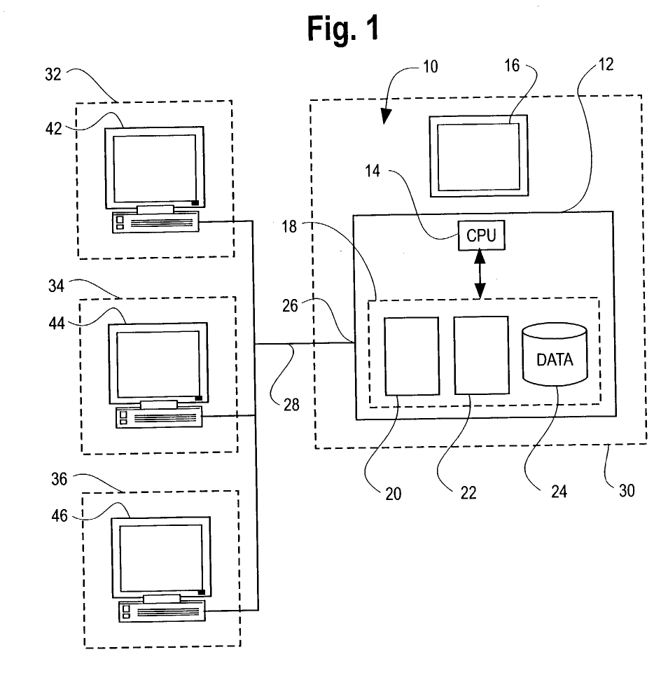

FIG. 1 shows a system 10 for calculating rents used by a property manager or a property management company. The system 10 includes a computer 12 which has a central processing unit 14 which is coupled to a monitor 16. The computer 12 has a storage device 18 that is preferably a hard disk drive. Various software may be loaded into the storage device 18 for configuring the central processing unit 14. The storage device 18 contains lease rental optimizer (“LRO”) software 20 which will be explained below. The preferred embodiment uses a spreadsheet program 22 which may be the Microsoft Excel spreadsheet program to implement presentation and input of data in conjunction with the LRO software 20 but may also be a web based application with a central database. The computer 12 further has a database 24 stored on the storage device 18. The database 24 is preferably a SQL Server type configuration, but any suitable software or hardware configuration may be used. The database 24 contains data relating to competitors rents and other information as will be detailed below.

The system 10 also includes a network port 26 that is used to compile data from other sources. The network port 26 is coupled to a network 28 that is preferably the Internet although other networks such as Intranets, LANs or WANs could be used to send the system 10. It is preferable to insure the security of the transmitted data through well known methods. The system 10 is contemplated to be used at a central office 30 of a property management business. Various properties are managed in diverse locations such as property management offices 32, 34 and 36. Each of the offices 32, 34 and 36 contain a network accessible computer 42, 44 and 46 respectively. Employees at each of the offices 32, 34 and 36 may thus compile data relating to rent, availability etc. as will be explained below and report the data to the system 10 via the network port 26. The data is preferably entered via a web based interface on a browser program installed on the computers 42, 44 and 46. Each office 32, 34 and 36 manages the leasing a number of rental units. The rental units are classified by number of bedrooms, number of bathrooms, floor plans etc., and different rents are determined for different types of units.

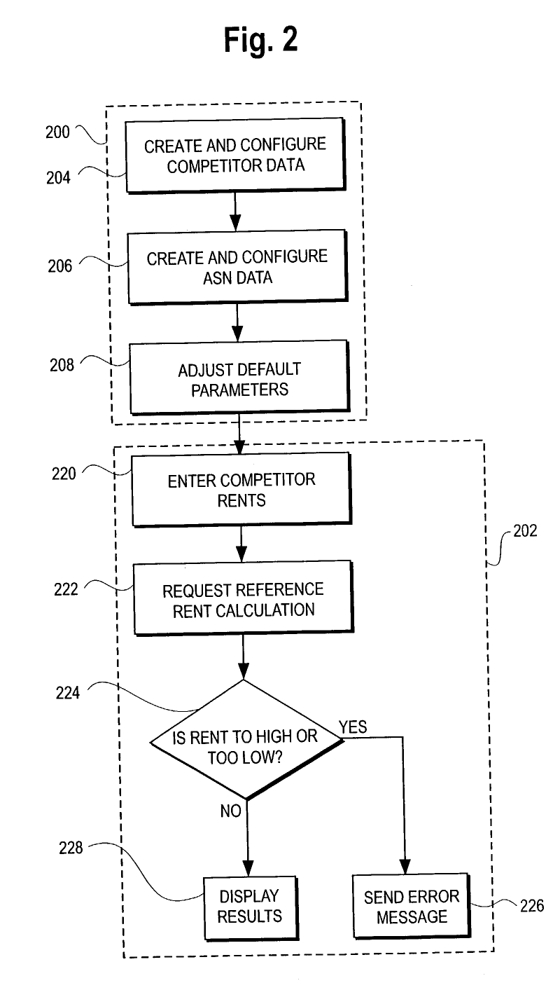

A user may operate the system 10 using a number of variables and develop a pricing model for the reference rent depending on the particular business permutation. The software 20 functions as a rent optimizer engine which takes data stored in the storage device 18. FIG. 2 is a flow chart of the general process used to determine the optimal rent. The flow chart includes a setup routine 200 and a periodic routine 202. The setup routine 200 includes first having a user creating and configuring competitors data in step 204. The competitor data includes unit type, unit description, lease term, low rent, high rent and other data as will be explained below. The program then proceeds to step 206 where a user creates and configures the community. The system authority makes any adjustments to default parameters such as low and high exposure thresholds and factors that define how aggressive the corporate strategy is in reacting to competitors in step 208.

The periodic routine 202 take place at periodic intervals such as each week and includes a user entering competitor rents for that period in step 220. The user then requests a reference rent calculation in step 222. The process validates that the reference rent is not too high or too low in step 224. If the rent is too high or too low, the system branches to step 226 and displays an error message. If the rent is within acceptable parameters, the system 10 then outputs the reference data in the form of competitor previous rents and current rents as well as previous reference rents and current reference rents in step 228.

There are a variety of set up variables used by the system to calculate the optimal rent in step 208. These include Competitor Weights, Competitor Position, Low Threshold, High Threshold, Brake Factor High Exposure, Brake Factor Medium Exposure and Aggressive Factor. The value of the set up variables is typically determined by a central administrative office for multiple leasing areas such as the central office 30 in FIG. 1. Of course the individual user may also input these values at a property management office or to reflect the relative differences in that area. The Competitor Weights is a percentage weight that each competitor contributes to the market composite. The Competitor Position is the relative position of the user versus a competitor at demand/supply equilibrium. The Competitor Position is a combination of physical factors (e.g. relative square footage, crown molding, etc.), equalization factors (e.g. utilities or parking included, etc.) and brand factors (e.g. achieving better rent per 2 square foot due to personnel, reputation, brand, etc.). For example, a competitor's property may be several years newer and a comparable unit type may have additional 4 features such as crown molding and larger square footage. In this situation, the position might be −$50, indicating that the unit type being analyzed is equivalent to competitor's price less $50. Similarly, if the unit type being analyzed had features that were superior to the competitor's unit type, the position would be a positive dollar value.

The Low Threshold variable is the maximum exposure in terms of rental units that have not been leased or are otherwise not committed that would still be considered “low” or acceptable for a 60-day exposure. The High Threshold variable is the minimum exposure that would still be considered “high” or unacceptable for a 60-day exposure.

The Brake Factor High Exposure is how much the user wants to put a brake or a stop on steeply declining reference rents caused by declining market composites when exposure is high. For example, a value of 100 would mean ignore the decline, i.e. “brake 100%” and keep rents at the present level while 0 would mean stay with the market composite no matter the decline. The Brake Factor Medium Exposure is how much a user wants to put a brake on steeply declining reference rents caused declining market composites when exposure is moderate. A factor of 100 would mean ignoring the decline, i.e. “brake 100%” while 0 would mean stay with market composite no matter the decline. Finally, the Aggressive Factor is the minimum the reference rent will be raised when exposure is low and the corporate strategy calls for raising the reference rent.

The user-entered variables entered in steps 204 and 206 include Competitor Rents, Competitor Concession, User Exposure, Recent Reference Rent Declines Significant and Recent Lease Velocity. The Competitor Rents is the typical rent currently being charged by the competitor for that unit type but is not a single unit price leader. The Competitor Concession is the typical concession or discount currently being offered by the competitor for that unit type but not a single unit price leader. The User Exposure is the low (less than low threshold percentage for 60-day), medium (between low_threshold percentage and high_threshold percentage for 60-day) or high (larger than high_threshold percentage for 60-day) threshold of exposure for the market. The Competitor Exposure is Low (less than low threshold percentage for 60-day), medium (between low_threshold percentage and high threshold percentage for 60-day) or high (greater than high_threshold percentage 60-day), or Ignore (either user doesn't know or user doesn't want the system to consider competitor's exposure). The Recent Reference Rent Declines Significant factor determines whether recent rent declines are deemed significant by the user. The Recent Lease Velocity is classified as high (which indicates that there has been no problem leasing units as they come available), medium (which indicates that a user has been able to lease units as needed), or low (a user has units which have been coming available faster than they can be leased).

The system generated input variables include a Reference Rent0 variable, an Override Reference Rent0 variable, and a Market Composite0 variable. The Reference Rent0 variable is the last iteration's reference rent as calculated by the system 10. The

Override reference rent variable is the last iteration's reference rent as accepted or overridden by the user. The Market Composite0 variable is the last iteration's calculation of the Competitive Market Composite variable.

The Output values from the system generated in step 222 include a Recommended Reference Rent value, a Market Composite1 value, an Override Reference Rent1 value, and a Text box values. The Recommended Reference Rent is the system's recommendation for the new reference rent. The Market Composite1 is the system's new calculation of the Competitive Market Composite of rents. The Override Reference Rent1 is a box for the user to override the reference rent. The Text box is for text that allows the system to explain which business zone it is in, provide other tips or prompts for action, etc.

After receiving the parameters outlined for user entered and system weights, an appropriate model is determined to produce the optimal rent, Ref1. The creation of the model to calculate the reference rent is based on the general formula of

a1*Comp1+a2*max(Comp1, Ref0*[1+Aggressive_Factor])+a3*Ref0+a4*(1+Aggressive_Factor)+a5*[Ref0+(1−Brake_Factor_{—}h)]*(Comp1−Comp0)+a6*[Ref0+(1−Brake_Factor_{—}m)]*(Comp1−Comp0)+a7*(Comp1−Comp0)+an*(Fn)

Where

a1-an are additional functional variable terms which may be weighted depending on the model desired;

Comp1 is the current competitor rent;

Comp0 is the competitor rent of the previous period;

Ref0 is the reference rent of the previous period;

Aggressive_Factor is the aggressive factor;

Brake_Factor_h is the high brake factor;

Brake_Factor_m is the medium brake factor; and

Fn is a variable for future influencing terms.

Several cases illustrate the flexibility of this approach. A first case is where exposure is low. In general, it is desirable to push the market rent up in this situation. If the market composite is up, it is also desirable to make sure that the market rent increase is at least as much as the market composite is going up. Coefficients are then set as:

Market composite going up: a2=1 all others=0

Market composite not going up: a4=1, all other=0

If the strategy is only to raise market rent when exposure is low and leasing velocity (LV) is favorable, then the LV parameter can be brought in so that the above is only true if LV is medium or high. If LV is low, the model can be set to have a1=1 and all other coefficients=0. Of course, users wishing a more or less aggressive strategy have the flexibility to choose different coefficients.

Similar strategies can be put into play when exposure is medium or high. The coefficients a5 and a6 allow the flexibility to be more aggressive in bringing prices down when exposure is high versus when it is medium. For example, if exposure is high and the market composite is going down, then a5 is set to 1 and all other coefficients set to 0. This lets the model bring down the rent towards the new market composite but not all the way down as driven by the Brake_factor_h setting.

If the exposure is medium and the market composite is going down, then a6 is set to 1 and all other coefficients set to 0. This lets the model bring down the rent towards the new market composite but not all the way down as driven by the Brake_factor_m setting.

It should be noted that, in normal operation, it is expected that Brake_Factor_h will be set to bring the new rent closer to the market composite than Brake_Factor_m would do since it's more imperative to be at or near market composite when exposure is high.

Coefficients a1, a3, and a4 can be turned “on” by setting them=1 and all other coefficients=0 for scenarios when it is desirable to match the composite market (a1), leave the reference the same as before (a3), or drive the aggressive factor independent of any other adjustment (a4). Practical examples of these scenarios include, but are not limited to the following.

When it is desirable to match the composite market (a1). In this case, exposure is high and leasing velocity is low (i.e. the situation is not good and getting worse so the strategy is to match the market immediately rather than using the brake_factor to slow down the rent decline).

Another example is leaving the reference rent the same as before (a3). In this case, exposure is low and leasing velocity is low (i.e. the market is resisting the current reference rent but the strategy is to wait until exposure gets worse before changing the rent).

A third example is driving the aggressive factor independent of any other adjustment (a4). In this case, exposure is low and it is known that the market composite has not been rising (i.e. there's no concern rent will be below market composite, so the strategy is simply to start testing higher rents).

Coefficient a7 is set to 1 and all others set to 0 when the business scenario calls for a strategy of maintaining the current spread between rent and market composite. For example, exposure could be medium or high which generally indicates rent should move towards the market composite, if rent is already above it. However, in circumstances where leasing velocity is high, prudent business logic would say the market is not adversely reacting to the “premium” vs. market. If the market composite is rising, then the corporate strategy in this case could be to maintain that spread. Setting coefficient a7 to 1 and all others to 0 enables this strategy to be implemented in these scenarios.

Coefficient an indicates how this process invention makes it possible for other calculations to be used should corporate strategy dictate adding other business cases and/or change the specific calculations for cases already identified.

The net result is a completely flexible response by creating a business-rule driven matrix of coefficient values for input permutations of exposure, leasing velocity and any other relevant data.

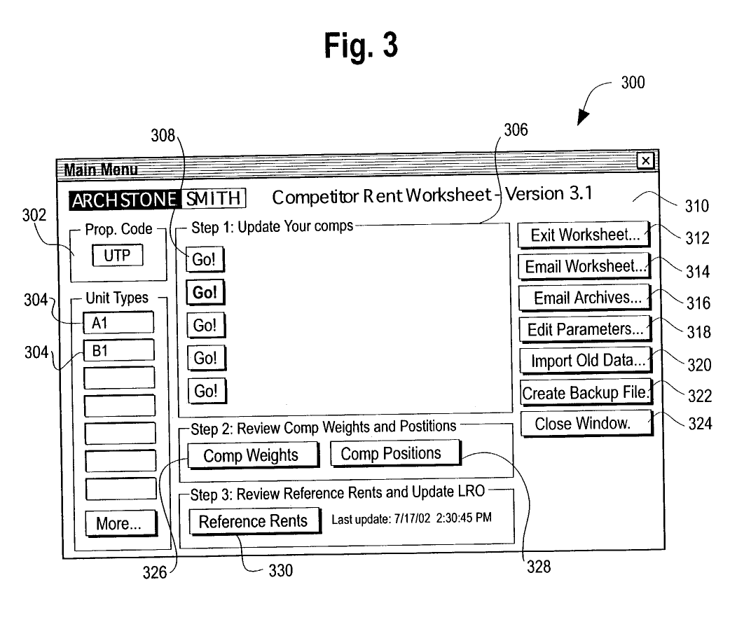

FIG. 3 shows the screen print of a community input screen 300 of the system 10 in FIG. 1 on the monitor 16. The community input screen 300 is the screen initially displayed by the system 10 where a user enters information about the community. The screen 300 includes a property code box 302 and a series of unit types boxes 304. The unit types boxes 304 include codes that represent different property unit types. A competitors box 306 allows a user to select a go button 308 to display a screen for each competitor and update the rents and concessions for those competitors. A command area 310 includes an exit worksheet button 312, an e-mail worksheet button 314, an e-mail archives button 316, an edit parameters button 318, an import old data button 320, a create back up file button 322 and:a close window button 324.

A competitor weight button 326 and a competitor positions button 328 allow a user to display data entry screens to update the competitor weight and position variables. Typically such positions will be updated periodically such as on a quarterly or monthly basis.

A reference rents button 330 allows a user to enter the number of available units for each unit type and select the current leasing velocity for the week from a drop down list on a separate screen.

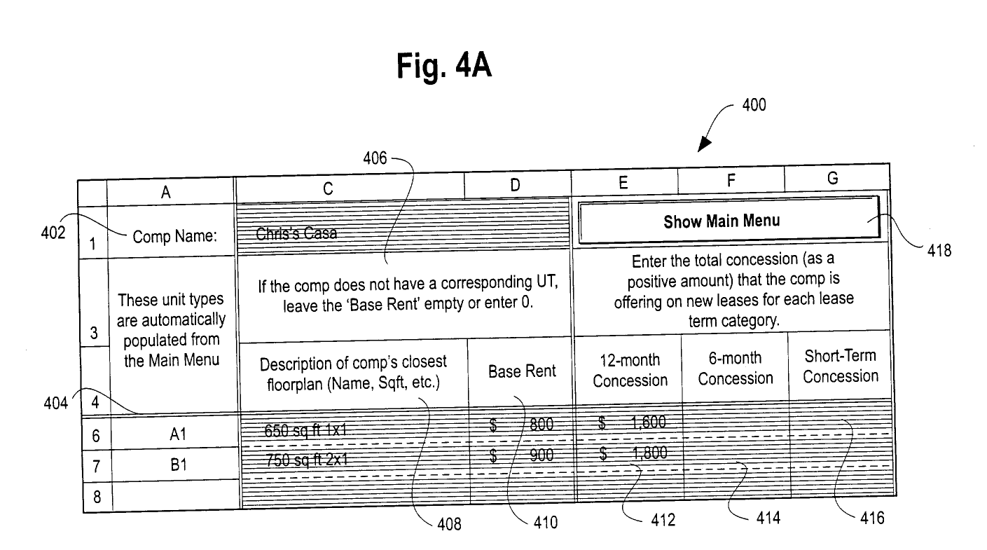

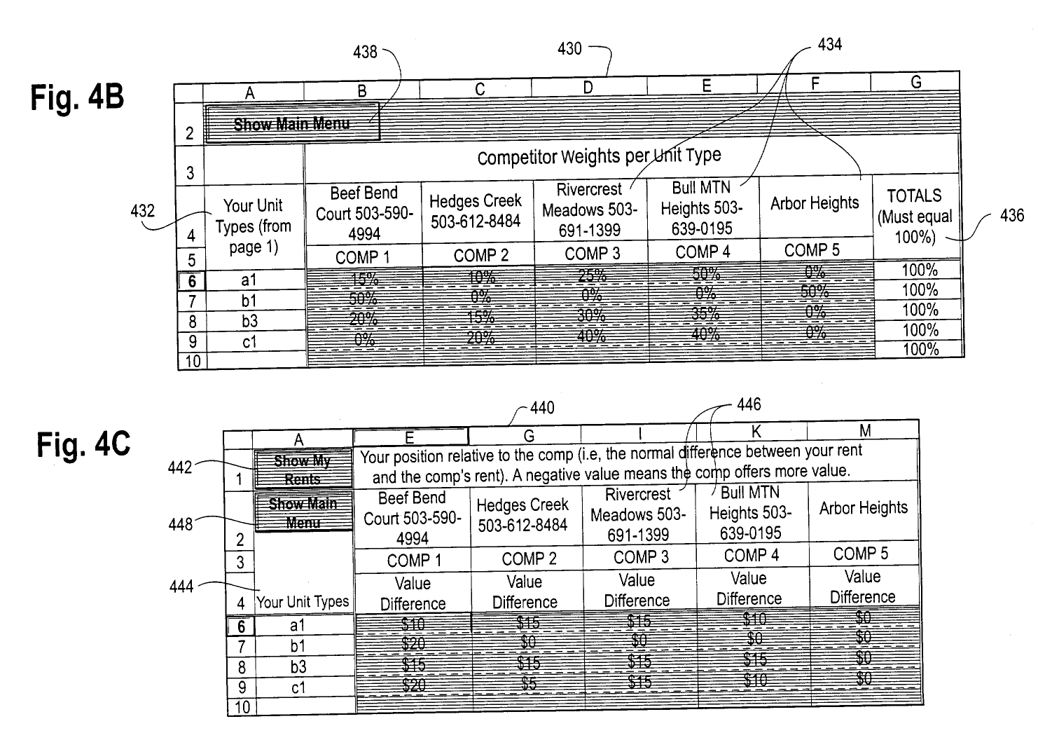

FIG. 4A shows a competitor rents worksheet 400 that is displayed when a user selects the Go buttons 308 in FIG. 3. The worksheet 400 has a competitor name row 402 and a unit type column 404 with codes for the unit type. A description column 406 has a floor plan description column 408 and a base rent column 410. A concession column has a 12 month concession column 412, a 6 month concession column 414 and a short term concession column 416. The main menu screen in FIG. 3 may be accessed by selecting a show main menu button 418. The user may enter different data relating to the competitor such as the floor plan in column 408, the base rent in column 410 or the concessions in columns 412-416

FIG. 4B shows a competitor weights worksheet 430 that is displayed by selecting the Comp Weights button 326 in FIG. 3. The competitor weights worksheet 430 displays unit types in a unit type column 432. A number of competitor columns 434 are listed and the percentage weights for each competitor when determined as explained above is entered for a totals column 436. The totals column 436 shows the net result of all the competitors in a particular unit type. The initial screen 300 may be displayed by selecting a show main menu button 438.

FIG. 4C shows a competitor positions worksheet 440 that is displayed by selecting the positions button 328 in FIG. 3. The competitors positions worksheet 440 includes a show my rents button 442 which allows user to display rents relating to their units. The competitors positions worksheet 440 also displays a unit type column 444 which uses the unit types defined in FIG. 3. A number of competitor columns 446 show all of the competitors that rent similar units. Each entry in the unit types column 444 for a particular competitor data under the competitor columns 446 includes an entry for the difference between the user rent and the competitor rent for that type of unit. A show main menu button 448 allows a user to return to the main screen 300 in FIG. 3.

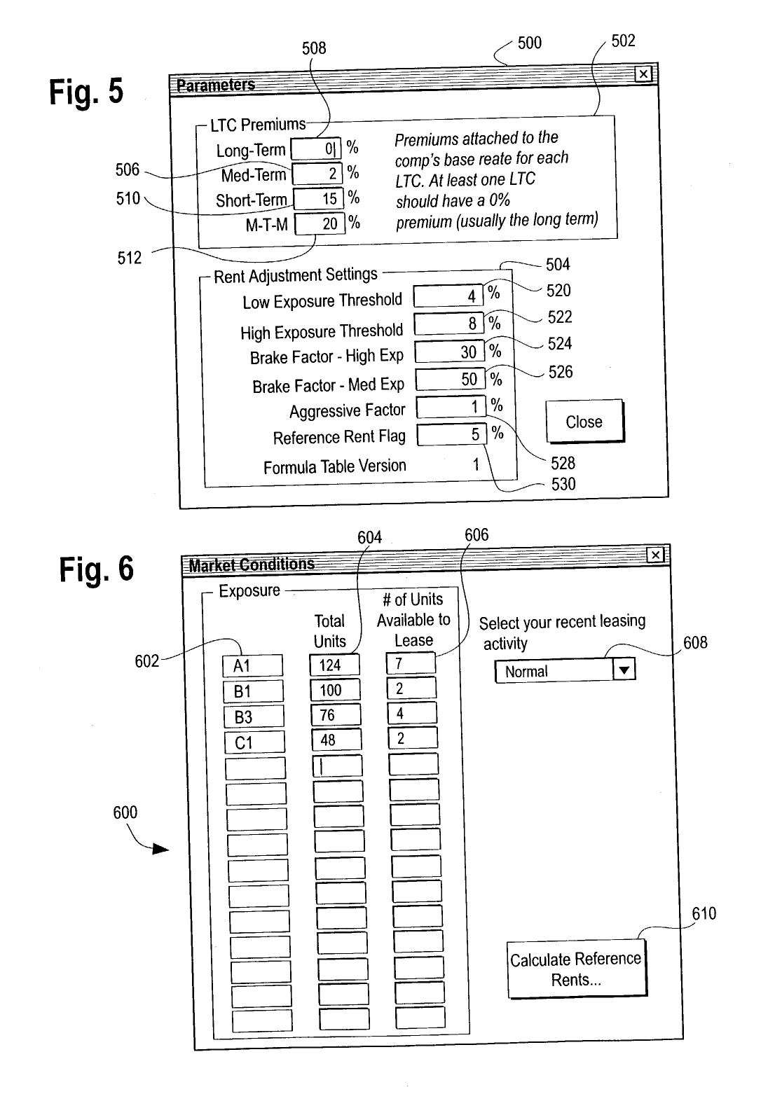

FIG. 5 shows a reference rent setup screen 500 for lease term categories LTC premiums. These premiums are built into the base rate premium setup for each lease term category and set by a percentage amount. The data entered by the user in the setup screen 500 establishes the initial conditions for the reference rent calculation in an LTC premiums area 502 and a rent adjustment settings area 504. The screen 500 includes a lo long term box 506, a mid term box 508, a short term box 510 and a month to month (“MTM”) box 512 for entering percentages for premiums for each lease term category. These are heuristic assessments (or assessments from offline analysis) that adjust for the fact that customers expect to pay a higher rate for shorter lease terms. The rent adjustment settings area 504 includes a low exposure threshold entry box 520, a high exposure threshold entry box 522, a brake factor high box 524, a brake factor medium box 526, an aggressive factor box 528 and a reference rent flag box 530. The various percentages in the rent adjustment settings may thus be adjusted for the reference rent calculation described in FIG. 2.

FIG. 6 shows a market conditions screen 600 that is displayed by selecting the reference rents button 330 in FIG. 3 and allows a user to enter data on specific numbers of units in the particular rental market. The market conditions worksheet 600 includes a column list of unit types 602. Each unit type has a total units box 604 and a units available box 606. The user enters the current number of units in each type in the appropriate total units box 604 and the units available of that type in the units available box 606. Such data entry is performed on a periodic basis such as weekly. In addition, the screen 600 has a leasing activity box 608 that allows a user to select whether their anticipated exposure is high, normal or low on a periodic such as weekly basis. Finally, the screen 600 has a calculate reference rents button 610 that allows a user to determine reference rents.

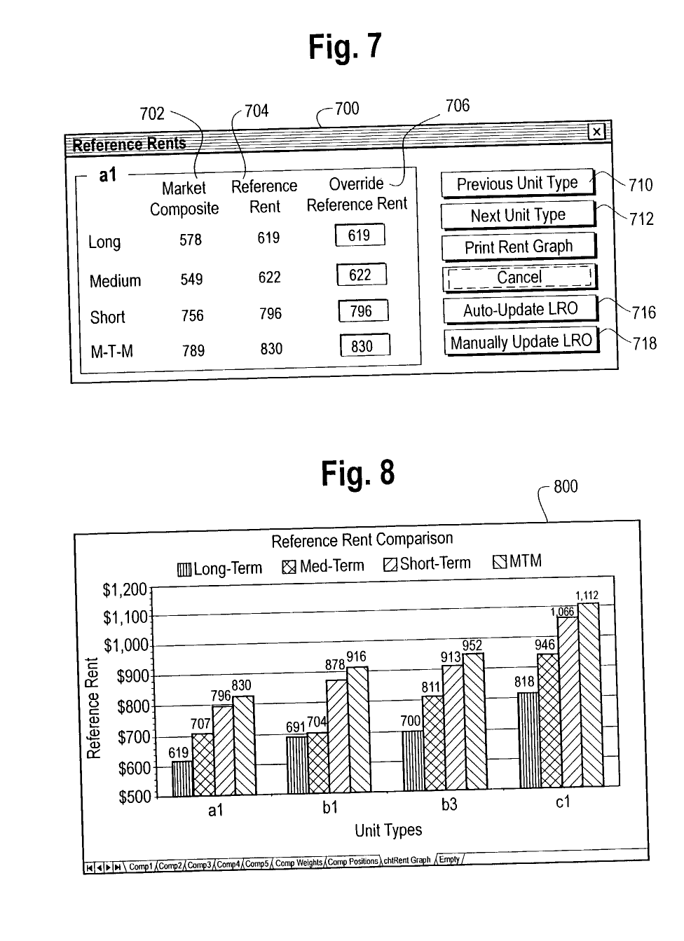

FIG. 7 shows a competitors rents worksheet 700 that is displayed by selecting the calculate reference rents button 610 in FIG. 6. The information for the first unit type is displayed. The worksheet 700 includes a market composite column 702, a reference rent column 704 and an override reference rent 706. The market composite column 702 and reference rent column 704 have set values for long, medium, short and month to month (“MTM”) term leases. These values are obtained the algorithm discussed above. The user may override the reference rent with their own entry by entering a new value in the override reference rent column 706. The worksheet 700 includes a next unit type button 710 and a previous unit type button 712 that allow a different unit type to be displayed. A user may move forward and backward along the unit types in the worksheet 700 by using the next unit type button 710 and the previous unit type button 710 respectively. A print rent graph button 714 will print a graph of the reference rents. An auto-update LRO button 716 will automatically update the LRO based on the entered values. A manually update LRO button 718 will print a set of the file information needed to enter reference rents manually into the LRO or any other system the user desires.

FIG. 8 shows a rent graph 800 generated as a result of the input data and by selecting the rent graph button 714 in the screen in FIG. 7. The rent graph 800 shows the reference rents for each unit type broken down by the term of the lease. The rent graph 800 has a vertical axis 802 which shows different levels of rental prices. A horizontal axis 804 has a number of bars representing the rents for each term lease of a particular class of rental unit. For example, the unit type a1 has a long term bar 806, a mid term bar 808, a short term bar 810 and a month to month bar 812 which show the reference rents for each of the lease terms.

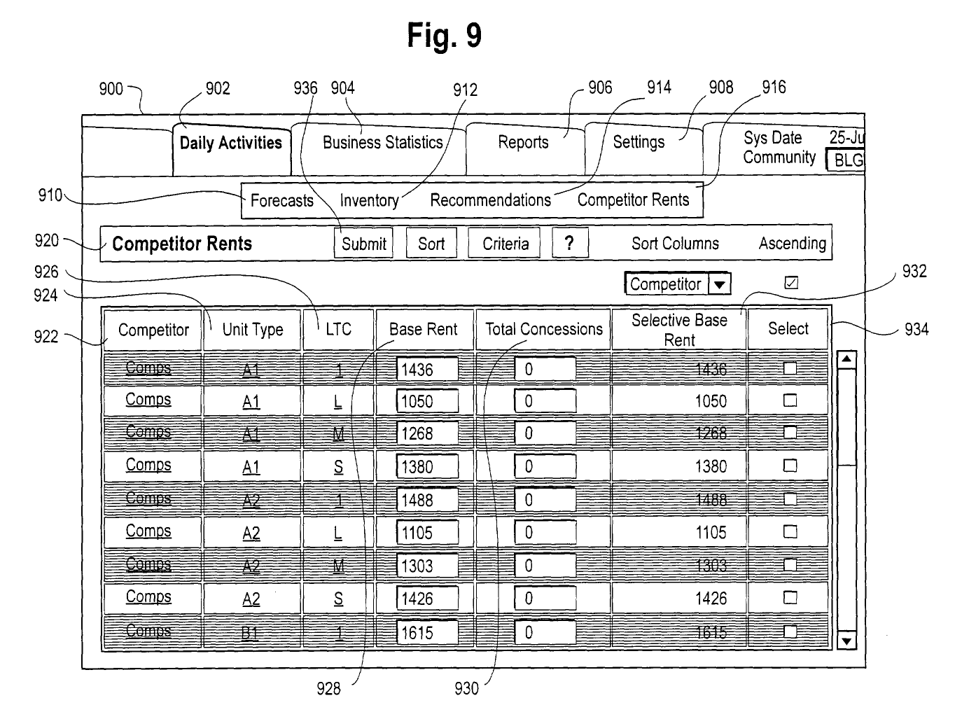

A user in the field such as a property manager can input data such as competitor rents and discounts via a web accessible data entry page. Of course other means for data transmission may be used such as computer transmission of electronic data, hard copy copied by a system administrator or direct input into the system 10. A web data entry page 900 is shown in FIG. 9 which is preferably displayed on a computer such as computer 42 in a property management office 32 in FIG. 1. The web page 900 may be accessed by any authorized property manager to report competitor and other field data. The web page 900 also allows a property manager to obtain data produced by the system 10 relating to reference rents.

The web page 900 has a series of tabs that allow data input an display. The tabs include a daily activities tab 902, a business statistics tab 904, a reports tab 906 and a settings tab 908. Various information may be displayed by selecting a forecasts area 910, an inventory area 912, a recommendations area 914 and a competitor rents area 916. The competitor rents area 916 has been selected in FIG. 9. A competitor rents table 920 is displayed. The competitor rents table 920 has a competitor column 922, a unit type column 924, a lease term column 926, a base rent column 928, a total concessions column 930, an effective rent column 932 and a selection box column 934. The user may enter base rent and concessions for each unit type and for each lease term in the boxes in the base rent column 928 and the total concessions column 930 as this information becomes available. Once a user has finished changing the various values, the user can submit the new data by selecting a submit button 936.

Additional functionality may be realized by the program that allows a user to attach a file to an email. The user may also create an archive via an email and create backup files for the various data discussed above.

It will be apparent to those skilled in the art that various modifications and variations can be made in the method and system of the present invention without departing from the spirit or scope of the invention. Thus, the present invention is not limited by the foregoing descriptions but is intended to cover all modifications and variations that come within the scope of the spirit of the invention and the claims that follow.

What is claimed is:

1. A method of calculating the optimal rent for a property, comprising:
gathering competitive data relating to past and current competitor rent;
storing previous reference rent data;
determining parameters for rental strategy including an aggressive factor, a high brake factor, and a medium brake factor; and
calculating optimal reference rent based on weighting current competitor rent, the reference rent data, the aggressive factor, the high brake factor, the medium brake factor and the past competitor rent.

2. The method of claim 1 wherein the optimal reference rent is determined for a particular type of rental unit.

3. The method of claim 1 wherein the competitor rent includes a factor for concessions.

4. The method of claim 2 further comprising displaying the calculated reference rents for each type of rental unit.

5. The method of claim 1 further comprising allowing the override of the calculated reference rent by a determined rent.

6. The method of claim 1 wherein the optimal reference rent is calculated using the formula:
a1*Comp1+a2*max(Comp1, Ref0*[1+Aggressive_Factor])+a3*Ref0+a4*(1+Aggressive_Factor)+a5*[Ref0+(1−Brake_Factor_{—}h)]*(Comp1−Comp0)+a6*[Ret0+(1−Brake_Factor_{—}m)]*(Comp1−Comp0)+a7*(Comp1−Comp0)
where
a1-a7 are additional functional variable terms which may be weighted depending on the rental model desired;
Comp1 is the current competitor rent;
Comp0 is the competitor rent of the previous period;
Ref0 is the reference rent of the previous period;
Aggressive_Factor is the aggressive factor;
Brake_Factor_h is the high brake factor; and
Brake_Factor_m is the medium brake factor.

7. The method of claim 1 wherein the optimal rent values are calculated periodically when new input variables are entered.

8. The method of claim 1 further comprising determining other variables as a factor in calculating the optimal rental value.

9. The method of claim 1 further comprising providing property managers with a computer accessible interface to periodically send competitor rent data.

10. A system for calculating optimal rental rates for a variety of renting strategies, the system comprising:
a storage device storing data relating to past reference rents, past competitor rents and present competitor rents;
an input device which accepts initial parameters including an aggressive factor, a high brake factor, and a medium brake factor; and
a rent optimizer engine coupled to the storage device and the input device which periodically calculates the optimal rent based on weighting current competitor rent, the reference rent data, the aggressive factor, the high brake factor, the medium brake factor and the past competitor rent.

11. The system of claim 10 further comprising a computer coupled to the storage device, the computer being configured to input competitor rents for storage in the storage device.

12. The system of claim 10 wherein the storage device includes a database structure and application software.

13. The system of claim 11 wherein the computer has a web based software interface allowing the entry of the competitor rents.

14. The system of claim 10 wherein the rate engine calculates the optimal rent based on the formula:
a1*Comp1+a2*max(Comp1, Ref0*[1+Aggressive_Factor])+a3*Ref0+a4*(1+Aggressive_Factor)+a5*[Ref0+(1−Brake_Factor_{—}h)]*(Comp1−Comp0)+a6*[Ref0+(1−Brake_Factor_{—}m)]*(Comp1−Comp0)+a7*(Comp1−Comp0)
where
a1-an are additional functional variable terms which may be weighted depending on the model desired;
Comp1 is the current competitor rent;
Comp0 is the competitor rent of the previous period;
Ref0 is the reference rent of the previous period;
Aggressive_Factor is the aggressive factor;
Brake_Factor_h is the high brake factor;
Brake_Factor_m is the medium brake factor.

15. The system of claim 10 wherein the reference rents are calculated for different types of rental units.

16. The system of claim 10 wherein the rental optimizer engine calculates new reference rents on a periodic basis.
